(19) United States
(12) Patent Application Publication
(10) Pub. No.: US 2005/0040696 A1
(43) Pub. Date: Feb. 24, 2005

(54) Wheel cover assembly for a vehicle wheel

(76) Inventor: Ching-Nu Chiu, Tainan Hsien (TW)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 10/634,575

(22) Filed: Aug. 5, 2003

(51) Int. Cl. B60B 7/06

(52) U.S. Cl. 301/37.35

(57) ABSTRACT

A wheel cover assembly includes an anchor member, a cover member, and a biasing member. The anchor member includes a base plate having an inner side, an outer side opposite to the inner side, and a shank hole formed through the inner and outer sides. The cover member includes a cover plate having a front side, a rear side opposite to the front side and disposed to confront the outer side of the base plate, and a shank extending from the rear side and passing through the shank hole. The shank has a distal end distal from the rear side of the cover plate and provided with a spring seat thereon. The biasing member is sleeved on the shank, and has one end abutting against the inner side of the base plate and an opposite end abutting against the spring seat.

### BACKGROUND OF THE INVENTION

1. Field of the Invention

The present invention relates to a wheel cover assembly, more particularly to a wheel cover assembly that includes anchor and cover members.

2. Description of the Related Art

Wheel cover assemblies are decorative coverings that are secured to vehicle wheels. Depending on the style of the wheel cover assembly, the covered area of the wheel may range from a small center portion of the wheel as in most general cases, to most of the exterior surface of the wheel when it is desired to simulate the appearance of large wheel rims found in racing cars.

As shown in FIGS. 1 and 2, a conventional wheel cover assembly 1 is adapted for use with a vehicle wheel that includes a wheel rim 101 and a tire body 102 mounted on the wheel rim 101. The wheel cover assembly 1 includes an anchor member 11 secured to the wheel rim 101, a cover member 12 disposed on an outer side of the anchor member 11, a retaining ring 13 disposed on an inner side of the anchor member 11, and a plurality of biasing members 14.

The anchor member 11 includes a disc-shaped base plate 110 and a plurality of engaging blocks 111 that extend from an inner side of the base plate 110 and that are angularly spaced apart from each other. The retaining ring 13 is disposed to engage radial inner sides of the engaging blocks 111 so as to force the engaging blocks 111 in radial outward directions, thereby enabling tight engagement between radial outer sides of the engaging blocks 111 and the wheel rim 101. Assembly holes 112 are formed through the inner and outer sides of the base plate 110 near the rim of the anchor member 11.

The cover member 12 includes a disc-shaped cover plate 120 that has a rear side disposed to confront the outer side of the base plate 110 and that has an area sufficient to conceal the anchor member 11. A plurality of assembly blocks 121 extend from the rear side of the cover plate 120, pass respectively through the assembly holes 112 in the base plate 110, and are formed with engaging holes 122, respectively. Each of the biasing members 14 has one end hooked on the retaining ring 13 and the other end hooked in the engaging hole 122 of a respective one of the assembly blocks 121. The biasing members 14 provide a biasing force for pulling the cover plate 120 toward the base plate 110.

When the conventional wheel cover assembly 1 is mounted on the wheel rim 101, the anchor member 11 is secured to the wheel rim 101, and since the cover member 12 is larger than the anchor member 11, the cover member 12 will cover some of the area of the tire body 102 accordingly. Therefore, by simply changing the size of the cover member 12, the covered extent of the tire body 102 may be varied to simulate the appearance of a large wheel rim commonly found in racing cars at a relatively low cost.

As shown in FIGS. 2 and 3, when the vehicle wheel installed with the conventional wheel cover assembly 1 moves over a bump on a road surface, the tire body 102 is likely to deform and push the cover member 12 away from the anchor member 11. Since the biasing members 14 interconnect the retaining ring 13 and the cover member 12, the cover plate 120 will be pulled toward the base plate 110 when the tire body 102 regains its initial shape after moving over the bump, thereby ensuring engagement between the anchor member 11 and the cover member 12 and between the anchor member 11 and the wheel rim 101.

The following are some of the drawbacks of the conventional wheel cover assembly 1:
1. Formation of the engaging holes 122 complicates manufacturing process of the wheel cover assembly 1 as it involves drilling through the assembly blocks 121.
2. The biasing members 14, which are hooked on the retaining ring 13 and the assembly blocks 121, are liable to escape from the same. Moreover, connecting the biasing members 14 to the assembly blocks 121 is a relatively inconvenient task.

### SUMMARY OF THE INVENTION

Therefore, the object of the present invention is to provide a wheel cover assembly that can overcome the aforesaid drawbacks associated with the prior art.

Accordingly, a wheel cover assembly of the present invention comprises an anchor member, a cover member, and a biasing member.

The anchor member is adapted to be secured to a vehicle wheel, and includes a disc-shaped base plate having an inner side, an outer side opposite to the inner side, and a shank hole formed through the inner and outer sides.

The cover member includes a disc-shaped cover plate having a front side, a rear side opposite to the front side and disposed to confront the outer side of the base plate, and a shank extending from the rear side and passing through the shank hole. The shank has a distal end distal from the rear side of the cover plate and provided with a spring seat thereon.

The biasing member is sleeved on the shank, and has one end abutting against the inner side of the base plate and an opposite end abutting against the spring seat so as to provide a biasing force for pulling the cover plate toward the base plate.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional wheel cover assembly;

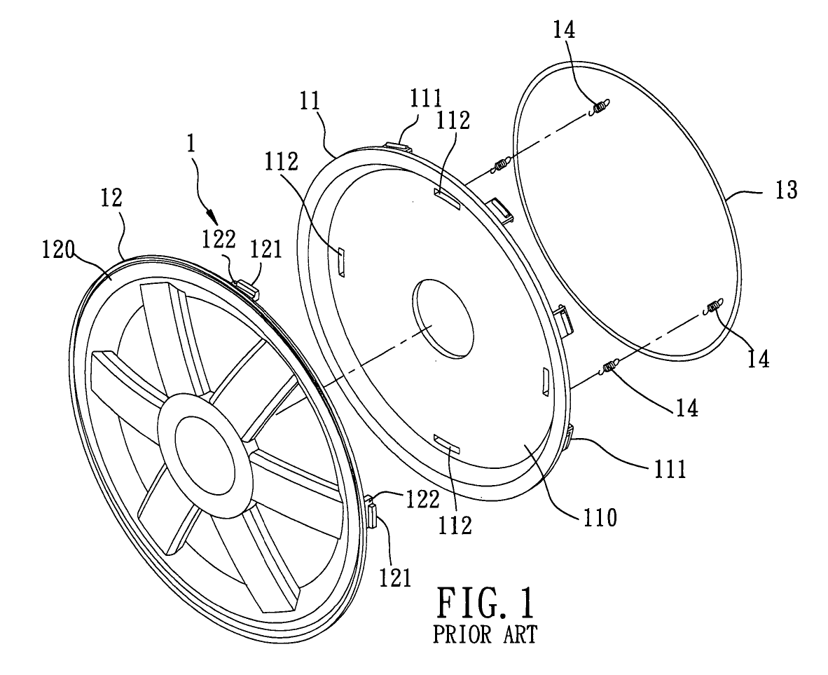

FIG. 2 is a fragmentary assembled sectional view of the conventional wheel cover assembly when installed on a vehicle wheel;

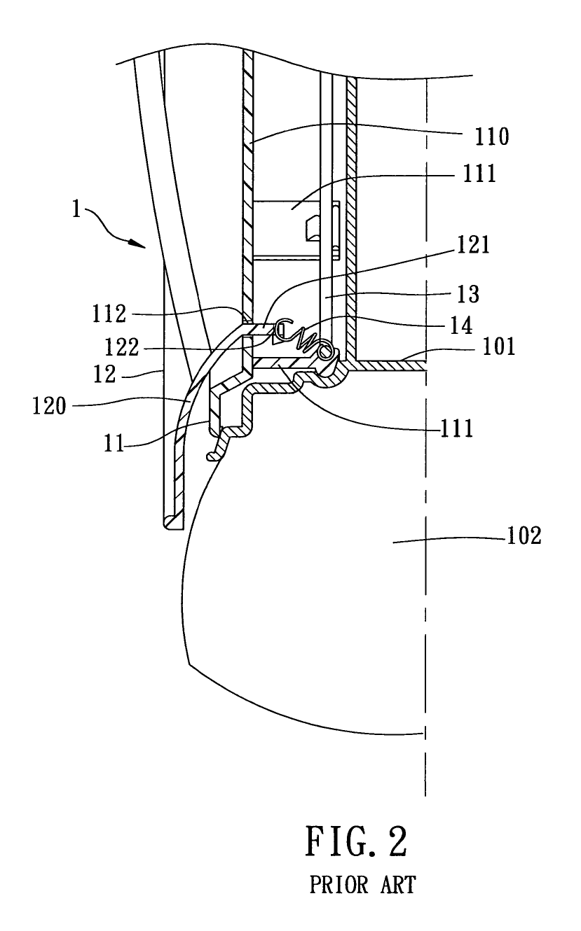

FIG. 3 is a view similar to FIG. 2, illustrating how the conventional wheel cover assembly reacts to movement of the vehicle wheel over a bump on a road surface;

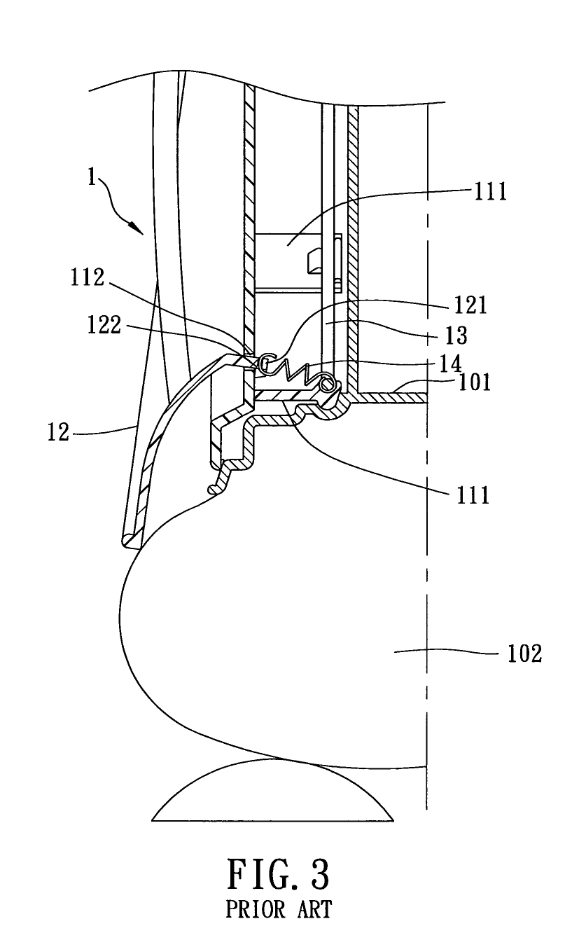

FIG. 4 is an exploded perspective view of the preferred embodiment of a wheel cover assembly according to the present invention;

FIG. 5 is a fragmentary assembled sectional view of the preferred embodiment; and

FIG. 6 is a view similar to FIG. 5, illustrating how the preferred embodiment reacts to movement of the vehicle wheel over a bump on a road surface.

### DETAILED DESCRIPTION OF THE PREFERRED EMBODIMENT

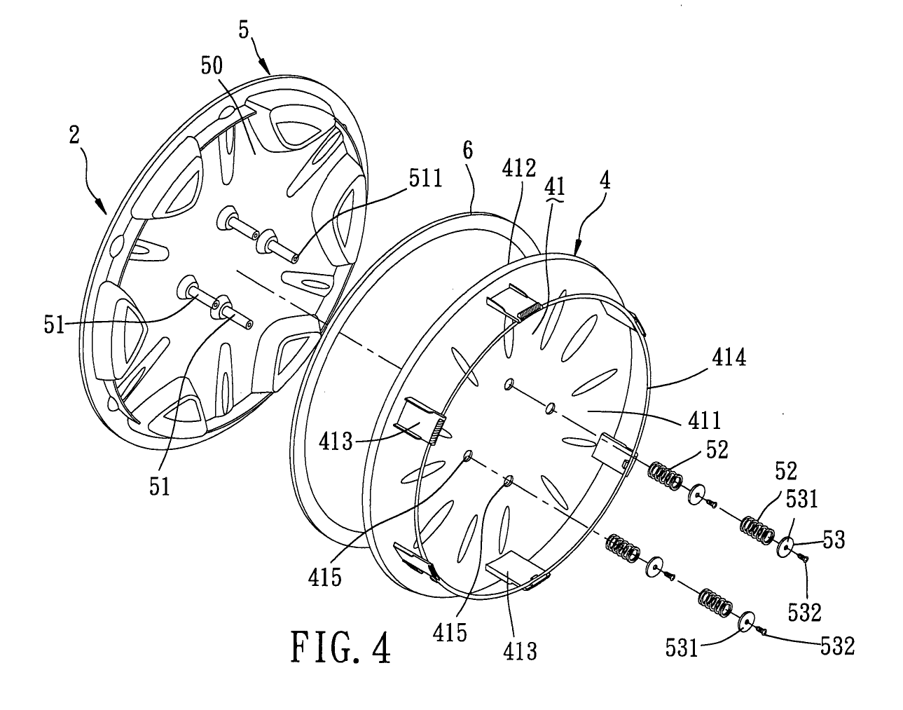

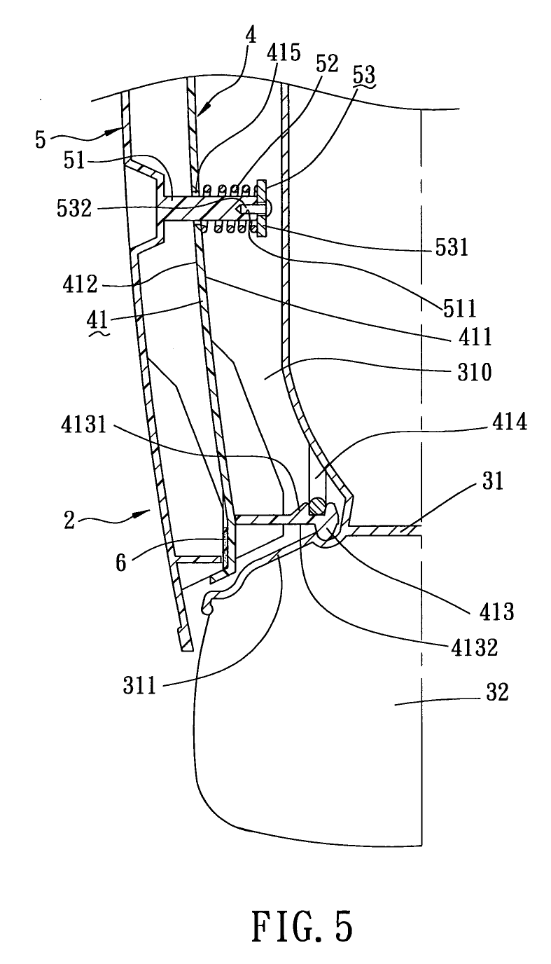

Referring to FIGS. 4 and 5, the preferred embodiment of a wheel cover assembly 2 according to the present invention is shown to include an anchor member 4, a cover member 5, and four biasing members 52.

The anchor member 4 is adapted to be secured to a vehicle wheel that includes a wheel rim 31 and a tire body 32 mounted on the wheel rim 31. The wheel rim 31 has an outer side formed with a cover mounting recess 310 that is defined by an annular side wall 311, as best shown in FIG. 5. The anchor member 4 includes a disc-shaped base plate 41 having an inner side 411, an outer side 412 opposite to the inner side 411, and four shank holes 415 formed through the inner and outer sides 411, 412. While the shank holes 415 are shown to be evenly distributed in a central portion of the base plate 41, the locations thereof maybe modified so as to be disposed near the rim of the base plate 41. The anchor member 4 is adapted to be disposed in the cover mounting recess 310, and further includes a plurality of resilient engaging blocks 413 and a retaining ring 414. The engaging blocks 413 extend from the inner side 411 of the base plate 41 and are angularly spaced apart from each other. Each of the engaging blocks 413 has radial outer and inner sides 4132, 4131 to be disposed proximate to and distal from the annular side wall 311, respectively. The retaining ring 414 is disposed to engage the radial inner sides 4131 of the engaging blocks 413 so as to force the engaging blocks 413 in radial outward directions, thereby enabling tight engagement between the radial outer sides 4132 of the engaging blocks 413 and the annular side wall 311 of the wheel rim 31.

The cover member 5 includes a disc-shaped cover plate 50 having a front side, a rear side opposite to the front side and disposed to confront the outer side 412 of the base plate 41, and four shanks 51, each of which extends from the rear side and passes through a respective one of the shank holes 415. Each of the shanks 51 has a distal end distal from the rear side of the cover plate 50 and provided with a spring seat 53 thereon. The cover plate 50 has an area sufficient to conceal the anchor member 4.

In this embodiment, the distal end of each of the shanks 51 is formed with a screw hole 511. Each spring seat 53 is an annular washer 531 that is disposed to abut against the distal end of the corresponding shank 51. The cover member 5 further includes four screw fasteners 532, each of which passes through a corresponding spring seat 53 and engages the screw hole 511 in the corresponding shank 51, thereby retaining the spring seats 53 on the shanks 51.

In this embodiment, each of the biasing members 52 is a coiled compression spring sleeved on a respective one of the shanks 51, and has one end abutting against the inner side 411 of the base plate 41 and an opposite end abutting against the spring seat 53 on the respective one of the shanks 51. The biasing members 52 provide a biasing force for pulling the cover plate 50 toward the base plate 41.

In practice, each spring seat 53 may be configured to be in the form of a radial flange formed on the distal end of the shank 51, or a nut mounted threadedly on the distal end of the shank 51, as long as the function of providing a surface for abutting against one end of the biasing member 52 is met.

Preferably, a buffer pad 6, in the form of a ring made from an elastomer, is mounted on the outer side 412 of the base plate 41 so as to be disposed between the outer side 412 of the base plate 41 and the rear side of the cover plate 50. The buffer pad 6 cushions impact between the anchor and cover members 4, 5 when the cover member 5 is pulled toward the anchor member 4 by the biasing members 52.

During assembly, the shanks 51 of the cover member 5 are extended through the shank holes 415 in the base plate 41. The biasing members 52 are then sleeved on the shanks 51, and the spring seats 53 are subsequently mounted on the shanks 51 with the use of the fasteners 532. Thereafter, the retaining ring 414 is disposed to engage the radial inner sides 4131 of the engaging blocks 413 of the base plate 41, and the anchor member 41 is subsequently fitted into the cover mounting recess 310 in the wheel rim 31 such that the radial outer sides 4132 of the engaging blocks 413 engage the annular side wall 311 of the wheel rim 31. Since the cover member 5 is larger than the anchor member 4, the cover member 5 will cover some of the area of the tire body 32 accordingly. Therefore, by simply changing the size of the cover member 5, the covered extent of the tire body 32 may be varied to simulate the appearance of a large wheel rim commonly found in racing cars.

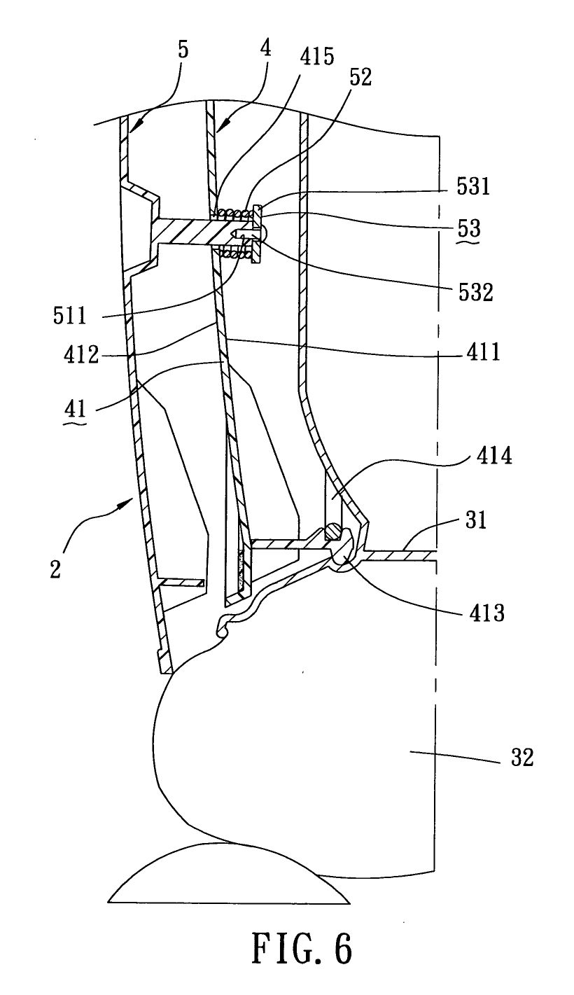

As shown in FIGS. 5 and 6, when the vehicle wheel installed with the wheel cover assembly 2 of this invention moves over a bump on a road surface, the tire body 32 is likely to deform and push the cover member 5 away from the anchor member 4. Due to the presence of the biasing members 52, the cover plate 50 will be pulled toward the base plate 41 when the tire body 32 regains its initial shape after moving over the bump, thereby ensuring engagement between the anchor member 4 and the cover member 5 and between the anchor member and the wheel rim 31.

As compared to the conventional wheel cover assembly 1 described hereinabove, mounting of the biasing members 52 is easier to conduct in the wheel cover assembly 2 of this invention. Moreover, since the biasing members 52 are sleeved on the shanks 51 and are confined between the base plate 41 and the spring seats 53, a secure and reliable connection is ensured in the wheel cover assembly 2 of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A wheel cover assembly for a vehicle wheel, comprising:
an anchor member adapted to be secured to the vehicle wheel and including a disc-shaped base plate having an inner side, an outer side opposite to said inner side, and a shank hole formed through said inner and outer sides;
a cover member including a disc-shaped cover plate having a front side, a rear side opposite to said front side and disposed to confront said outer side of said base plate, and a shank extending from said rear side and passing through said shank hole, said shank having a distal end distal from said rear side of said cover plate and provided with a spring seat thereon; and
a biasing member sleeved on said shank and having one end abutting against said inner side of said base plate and an opposite end abutting against said spring seat so as to provide a biasing force for pulling said cover plate toward said base plate.

2. The wheel cover assembly as claimed in claim 1, the vehicle wheel including a wheel rim and a tire body mounted on the wheel rim, the wheel rim having an outer side formed with a cover mounting recess that is defined by an annular side wall, wherein said anchor member is adapted to be disposed in the cover mounting recess and further includes:
a plurality of resilient engaging blocks that extend from said inner side of said base plate and that are angularly spaced apart from each other, each of said engaging blocks having radial outer and inner sides to be disposed proximate to and distal from the annular side wall, respectively; and
a retaining ring disposed to engage said radial inner sides of said engaging blocks so as to force said engaging blocks in radial outward directions, thereby enabling tight engagement between said radial outer sides of said engaging blocks and the annular side wall of the wheel rim.

3. The wheel cover assembly as claimed in claim 1, wherein said distal end of said shank is formed with a screw hole, said spring seat being an annular washer that is disposed to abut against said distal end of said shank, said cover member further including a screw fastener passing through said spring seat and engaging said screw hole, thereby retaining. said spring seat on said shank.

4. The wheel cover assembly as claimed in claim 1, wherein said biasing member is a coiled compression spring.

5. The wheel cover assembly as claimed in claim 1, further comprising a buffer pad disposed between said outer side of said base plate and said rear side of said cover plate.

6. The wheel cover assembly as claimed in claim 1, wherein said cover plate has an area sufficient to conceal said anchor member.

7. A wheel cover assembly for a vehicle wheel, comprising:
an anchor member adapted to be secured to the vehicle wheel and including a disc-shaped base plate having an inner side, an outer side opposite to said inner side, and a plurality of shank holes formed through said inner and outer sides;
a cover member including a disc-shaped cover plate having a front side, a rear side opposite to said front side and disposed to confront said outer side of said base plate, and a plurality of shanks extending from said rear side and passing through said shank holes, respectively, each of said shanks having a distal end distal from said rear side of said cover plate and provided with a spring seat thereon; and
a plurality of biasing members sleeved respectively on said shanks and having one end abutting against said inner side of said base plate and an opposite end abutting against said spring seat on the respective one of said shanks so as to provide a biasing force for pulling said cover plate toward said base plate.

8. The wheel cover assembly as claimed in claim 7, wherein said shank holes are evenly distributed in said base plate.
